(19) United States
(12) Patent Application Publication
(10) Pub. No.: US 2016/0296830 A1
(43) Pub. Date: Oct. 13, 2016

(54) SKATEBOARD LIGHTING APPARATUS

(71) Applicant: John Peter Turner, Miami Beach, FL (US)

(72) Inventor: John Peter Turner, Miami Beach, FL (US)

(21) Appl. No.: 14/682,345

(22) Filed: Apr. 9, 2015

(51) Int. Cl. A63C 17/26; F21V 8/00

(52) U.S. Cl. CPC A63C 17/26; G02B 6/0073; G02B 6/0081

(57) ABSTRACT

A skateboard lighting apparatus is provided. The skateboard lighting apparatus includes a translucent plate and a light emitting diode assembly. The translucent plate may include an upper surface, a lower surface, and an outer edge. The translucent plate may be substantially flat and may be made of a polymer, such as a plastic. The outer edge of the translucent plate is sized to fit on the bottom of a skateboard platform. The light emitting diode assembly includes at least one light emitting diode (LED) that directs light onto the translucent plate. The translucent plate lights up and the present invention is used as a lighting system for a skateboard.

### BACKGROUND OF THE INVENTION

The present invention relates to skateboards and, more particularly, to a skateboard lighting apparatus.

Skateboarding is an action sport which involves riding and performing tricks using a skateboard. Skateboarding can also be considered a recreational activity, an art form, or a method of transportation. The sport of skateboarding is practiced globally both day and night. Like riding a bicycle, many young people engage in skateboarding at night when they are not seen and in danger of getting hit by a car.

As can be seen, there is a need for a method and apparatus for lighting a skateboard.

### SUMMARY OF THE INVENTION

In one aspect of the present invention, a skateboard lighting apparatus comprises: a translucent plate comprising an upper surface, a lower surface and an outer edge sized to be secured to a bottom of a skateboard; and a light emitting diode assembly securable to the skateboard and positioned to emit light towards the translucent plate.

In another aspect of the present invention, a method of amplifying light emitted from a skateboard comprises: attaching a translucent plate to a bottom of the skateboard; and attaching a light emitting diode assembly to the bottom of the skateboard so that the light emitting diode assembly emits light onto the translucent plate.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a lower perspective view of the present invention;

FIG. 3 is a lower detail perspective view of the present invention;

FIG. 4 is a perspective view of the present invention LED light assembly;

FIG. 5 is a lower perspective exploded view of the present invention;

FIG. 6 is a section detail view of the present invention along line 6-6 in FIG. 2;

FIG. 7 is a lower perspective detail view of an alternate embodiment of the present invention;

FIG. 8 is a lower perspective view of an alternate embodiment of the present invention;

FIG. 9 is an upper perspective view of an alternate embodiment of the present invention;

FIG. 10 is a lower perspective exploded view of an alternate embodiment of the present invention;

FIG. 11 is a perspective detail view of the present invention demonstrating LED light assembly in a molded cavity; and

FIG. 12 is a section detail view of the present invention along line 12-12 in FIG. 11.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a skateboard safety device including an illuminated translucent plate affixed to the underside of a recreational skateboard of any size. The clear plastic translucent plate is highly illuminated by a series of light emitting diodes (LEDs) and act as a set of head beams emanating from beneath the skateboard. When the LED array is in direct contact with the translucent plastic plate assembly, the LED output is inherently and greatly magnified by the characteristics common to translucent plastics. Once the LED array is in direct contact with the plate, the resulting light emitted about the entire perimeter of the plate. The plate may be attached permanently or temporarily to the bottom side of any skateboard.

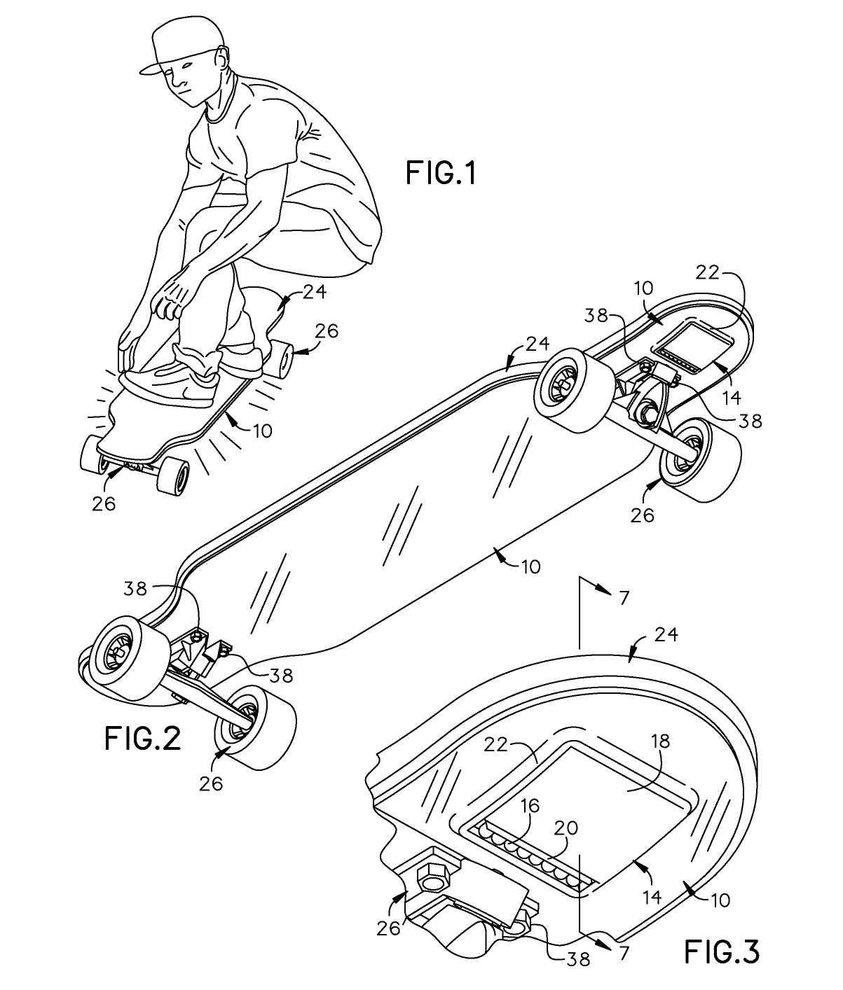

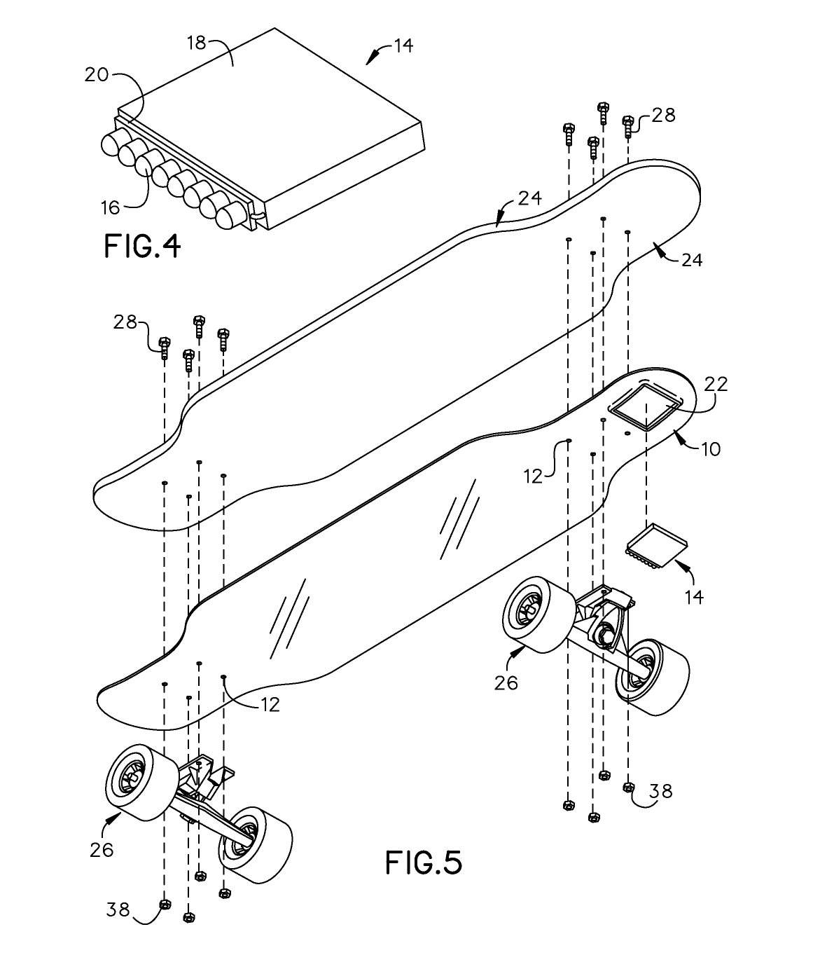

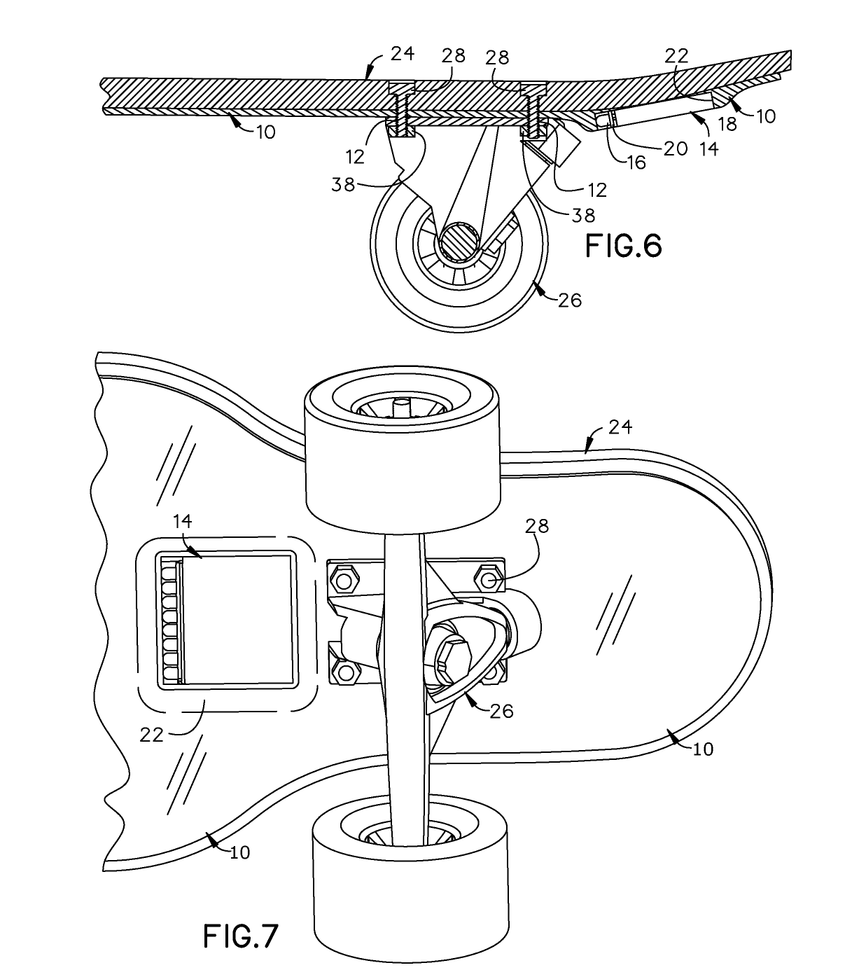

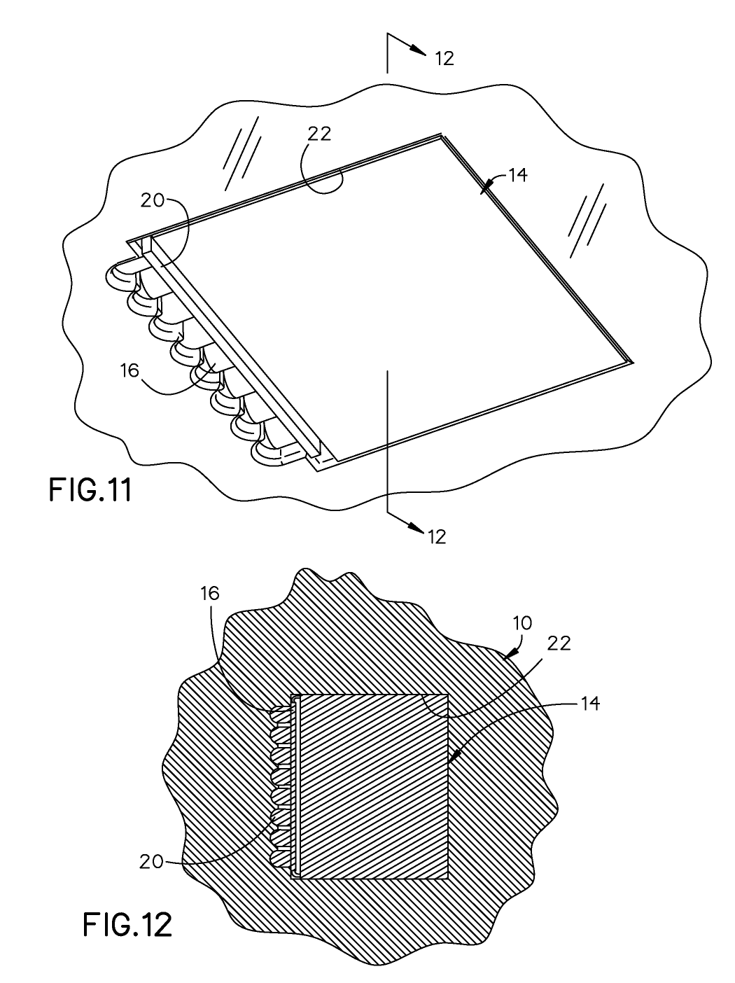

Referring to FIGS. 1 through 12, the present invention includes a skateboard lighting apparatus. The skateboard lighting apparatus includes a translucent plate 10 and a light emitting diode assembly 14. The translucent plate 10 may include an upper surface, a lower surface, and an outer edge. The translucent plate 10 may be substantially flat and may be made of a polymer, such as a plastic. A design 40 may be etched on the lower surface. The outer edge of the translucent plate 10 is sized to fit on the bottom of a skateboard platform 24. The light emitting diode assembly 14 includes at least one light emitting diode (LED) 16 that directs light onto and into the translucent plate 10. The translucent plate 10 lights up and the present invention is used as a lighting system for a skateboard.

The light emitting diode assembly 14 is attachable to the bottom of the skateboard platform 24 or attachable directly to the translucent plate 10. The light emitted from the LEDs 16 may planar to the translucent plate 10 so that light is emitted from the outer edge of the plate 10 in all directions. The light emitting diode assembly 14 includes the LEDs 16, a circuit board 20, and a battery 18. A plurality of LEDs 16 may be attached to the circuit board 20 which is electrically connected to the battery 18. The battery 18 may be rechargeable or replaceable. In certain embodiments, the light emitting diode assembly 14 may include wireless capabilities so that the LEDs may be turned on and off as well as change color of via a controller. The controller may include a smart device with a downloadable application.

The present invention may include multiple configurations. The translucent plate 10 may include a cavity 22 formed in the lower surface of the plate 10. The cavity 22 is sized to receive the light emitting diode assembly 14 within. Therefore, the light emitting diode assembly 14 is mounted within the plate 10 and emits light planar to the plate 10. The cavity 22 may be placed in front of the truck 26 or behind the truck 26. Alternatively, the plate 10 may be secured to the skateboard platform 24 and the light emitting diode assembly 14 may be secured to the skateboard platform 24. In such embodiments, the LEDs 16 of the light emitting diode assembly 14 may be adjacent to the outer edge of the translucent plate 10, and may thereby emit light planar to the translucent plate 10.

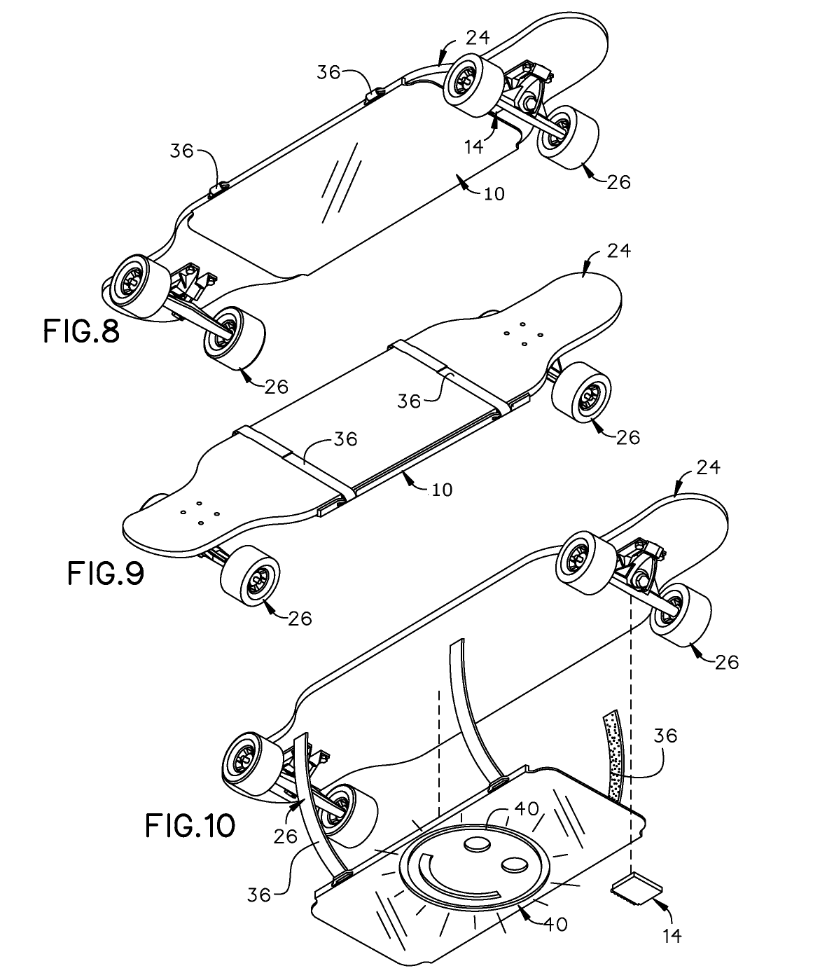

The translucent plate 10 may be secured to the bottom of the skateboard platform by fasteners, adhesives, straps and the like. In certain embodiments, the plate 34 may include a plurality of openings 12 therethrough that are oriented to align with openings of the skateboard platform 24 and the skateboard truck 26. The plate 34 is thereby secured in between the platform 24 and the trucks 26 by screws 28 and nuts 38. As illustrated in FIGS. 8 through 10, a plurality of straps 36 may be secured to the outer edge of the translucent plate 10. The straps 36 may wrap around the skateboard platform 24 and secure via a hook and loop fasteners, clips, snaps, buckles, and the like.

A method of amplifying light emitted from a skateboard may include the following. The translucent plate is first secured to the bottom of the skateboard. The light emitting diode assembly is secured to the plate, the trucks or the bottom of the skateboard so that the light emitting diode assembly emits light onto the translucent plate. The light emitting diode assembly is positioned to emit light planar with the translucent plate. Simply turn on the light assembly and enjoy a night skateboarding session completely visible to oncoming vehicular traffic.

A method of making the present invention may include the following. A clear sheet of acrylic or Plexiglass® is acquired. Cut to the shape and outline of skateboard deck as a pattern. Drill out holes, such as eight holes, for placement of attachment hardware for a skateboard deck truck attachment or simply use straps to connect the plate to the underside of the skateboard deck. Solder wire leads to a 3-4, switch enabled battery pack of AAA batteries. Place LED circuit array against any edge convenient found on the perimeter of the plate, or cute out a cavity. Once LED placement has been determined, a hot glue gun can be utilized to permanently affix the LED array to board deck. Turn on battery pack and safely proceed with your night skateboarding session.

It should be understood, of course, that the foregoing relates to exemplary embodiments of the invention and that modifications may be made without departing from the spirit and scope of the invention as set forth in the following claims.

What is claimed is:

1. A skateboard lighting apparatus comprising:
a translucent plate comprising an upper surface, a lower surface and an outer edge sized to be secured to a bottom of a skateboard; and
a light emitting diode assembly securable to the skateboard and positioned to emit light towards the translucent plate.

2. The skateboard lighting apparatus of claim 1, wherein the light emitting diode assembly comprises a plurality of light emitting diodes.

3. The skateboard lighting apparatus of claim 1, wherein the light emitting diode assembly is positioned to emit light planar with the translucent plate.

4. The skateboard lighting apparatus of claim 1, wherein a cavity is formed in the lower surface of the translucent plate, and is sized to receive the light emitting diode assembly.

5. The skateboard lighting apparatus of claim 1, wherein the light emitting diode is positioned to face the outer edge.

6. The skateboard lighting apparatus of claim 1, wherein the translucent plate comprises a plurality of openings therethrough oriented to align with openings of a skateboard and a skateboard truck.

7. The skateboard lighting apparatus of claim 1, further comprising a plurality of straps attached to the outer edge and sized to secure the translucent plate to a skateboard.

8. The skateboard lighting apparatus of claim 7, wherein the plurality of straps each comprise a hook and loop fastener.

9. A method of amplifying light emitted from a skateboard comprising:
attaching a translucent plate to a bottom of the skateboard; and
attaching a light emitting diode assembly to the bottom of the skateboard so that the light emitting diode assembly emits light onto the translucent plate.

10. The method of claim 9, wherein the light emitting diode assembly is positioned to emit light planar with the translucent plate.
